(19) United States
(12) Patent Application Publication
(10) Pub. No.: US 2004/0010713 A1
(43) Pub. Date: Jan. 15, 2004

(54) EAP telecommunication protocol extension

(76) Inventors: John R. Vollbrecht, Dexter, MI (US); Robert G. Moskowitz, Oak Park, MI (US)

Correspondence Address: STEPTOE & JOHNSON LLP, Stuart T.F. Huang/ BOX USPTO, 1330 Connecticut Avenue, NW, Washington, DC, 20036, US

(21) Appl. No.: 10/193,296

(22) Filed: Jul. 12, 2002

(51) Int. Cl. H04L 9/00

(52) U.S. Cl. 713/201

(57) ABSTRACT

A method for providing a network connection includes a step of initiating an EAP connection between a device seeking network access and a network by way of a network access server. The network access server is configured to selectively permit—or deny—network access. Using EAP formatted messages, the device seeking network access negotiates for an additional credential that grants an authorization for a service other than network access. The network preferably provides the credential prior to completing the EAP process for granting network access.

### BACKGROUND OF THE INVENTION

1. Field of the Invention

The invention relates to telecommunications protocols.

2. Discussion of Background Information

Telecommunications architectures are frequently described as has having layers in which the capability of a higher layer relies on capability of a lower layer. For example, a lowest layer might be considered a physical layer that provides a physical medium and a capability of transmitting bits of information, with little regard to the organization of the information. A higher layer may be a data layer that provides an organization for data, such as framing, error detection, etc. An even higher layer may be a network layer that provides more complex functionality, such as packet routing, addressing, etc.

During creation of a connection, devices typically establish lower-layer connections first, and then establish higher-layer connections using lower-layer ones. For example, when a device connects to a computer network over a dial-up modem, the device typically will first establish a physical connection to the network by obtaining a telephone connection through the public switch telephone network and transmitting (or acquiring) a modem tone. The device and network will then establish a data layer to regulate the transmission of digital data. The device and network may then establish higher-layer protocols for more complex functionality, such as network login, file transfer, etc.

Various architectures for telecommunications are defined by standards organizations, such as the Institute for Electrical and Electronic Engineering (IEEE), the International Telecommunications Union (ITU), and the Internet Engineering Task Force (IETF). Many architectures include some provision for the establishment of physical layers and data layers. For example, the IEEE 802 Working Group has promulgated a series of standards, such as IEEE 802, “IEEE Standard for Local and Metropolitan Area Networks: Overview and Architecture.” Within the IEEE 802 series is IEEE 802.11, “IEEE Standard for Information Technology—Telecommunications and Information Exchange between Systems—Local and Metropolitan Area Network—Specific Requirements—Part 11: Wireless LAN Medium Access Control (MAC) and Physical Layer (PHY) Specifications,” which, among other things, defines mechanisms for establishing and releasing physical layers and data layers.

The Point-to-Point Protocol (“PPP”) is a relatively low layer protocol that assumes the existence of a physical layer and provides a method for communicating relatively simple datagrams over point-to-point links. A definition of the protocol can be found in the Internet Engineering Task Force (“IETF”) Network Working Group Request for Comments: 1661, “The Point-to-Point Protocol (PPP)” (“PPP RFC”).

FIG. 1 illustrates the formation of a data connection between two devices using PPP. A physical link 11 provides a communication medium between two devices 13, 15, each called a “peer.” The link and peers also provide a foundation for physically exchanging datagrams made up of binary data. Hereafter all communications shall be considered to be binary datagrams. FIG. 1 illustrates the exchange of binary datagrams in conformance with the PPP RFC as a PPP connection 17.

FIG. 2 illustrates a phase diagram for two devices establishing a connection using PPP. A peer may change state upon occurrence of an event. Events typically are receipt of an appropriate datagram from another peer, but they could be other events, such as a loss of the physical connection. Each peer maintains its own state and progresses through the states according to events it experiences.

Each peer begins in a Link Dead phase 21 in which the physical layer is not available for exchange of datagrams. For example, prior to making a dial-up modem connection, the physical layer is not ready.

A peer may advance to the Link Establishment Phase 23 upon occurrence of an “UP” event, such as a signal from a modem that it has acquired a carrier and is capable of exchanging datagrams. During the Link Establishment phase, peers may establish and test the link using a Link Control Protocol defined in the PPP RFC. If a peer requires use of an authentication protocol, it must negotiate with the other peer to use the protocol during the Link Establishment Phase 23. (Authentication negotiation selects an authentication method. Actual authentication takes place later, as discussed below.) Regardless of the result of the authentication negotiation, the link is considered “OPENED” upon successful completion of the Link Establishment Phase.

If the peers have successfully negotiated use of an authentication protocol, they proceed from the Link Establishment Phase 23 to the Authentication Phase 25. They may engage in any of a number of authentication protocols defined outside the PPP RFC but generally known in the art and may be, for example, Internet Protocol (“IP”), Appletalk, etc. Upon successful completion of the authentication protocol, the peers enter the Network-Layer Protocol Phase 27, during which they may communicate using a higher level protocol. Network Layer Protocols are defined outside the PPP RFC but are generally known in the art and may be, for example, Internet Protocol (“IP”), Appletalk, etc. In the absence of authentication, the peers may directly enter the Network-Layer Protocol Phase 27 from the Link Establishment Phase 23.

A Link Termination Phase governs termination of the link. Peers may advance to the Link Terminate Phase 29 in any of a variety of ways. Termination could occur because of a physical link failure, an authentication failure, normal termination of the Network-Layer Protocol Phase 27, or other reason. If a link closes normally, peers may exchange termination messages. If a link closes abnormally, messages may be sent to inform the Network Layer Protocol process of the termination.

After termination, the link is considered “DOWN” and the peers return to the Dead Phase 21.

### SUMMARY OF THE INVENTION

Aspects of the invention are summarized here. Other aspects may be ascertained by reviewing the complete disclosure, including accompanying drawings and referenced materials.

In a telecommunication architecture having a limited-access network, an authentication server selectively permits—or denies—access to the network. The EAP protocol provides a framework for a device to negotiate such network access. The device might be connecting through a dial-up modem, wireless connection, dedicated line, or other physical communication medium. Various authentication methods may be used within the EAP framework.

The device seeking network access additionally negotiates for a credential at the time it initiates a network connection. The credential authorizes the device to some network service other than network access. Network access is delayed by, but not conditioned on, the negotiation for the credential. If the device otherwise successfully authenticates to the network, network access will be granted regardless of the result of the negotiation for the additional credential.

### BRIEF DESCRIPTION OF THE DRAWINGS

The present invention is further described in the detailed description which follows, in reference to drawings by way of non-limiting examples of certain embodiments of the present invention, in which like numerals represent like elements throughout the several views of the drawings, and wherein:

FIG. 1 illustrates formation of a connection between two devices using PPP;

FIG. 2 illustrates a phase diagram for two devices establishing a connection using PPP;

FIG. 3 illustrates steps in the formation of a connection common to several scenarios;

FIG. 4 illustrates messages exchanged between an authenticator and a peer common to several scenarios;

FIG. 5 illustrates entities participating in a first scenario in which a remote device declines an offer to negotiate an additional credential;

FIG. 6 illustrates messages of the first scenario in which a remote device declines an offer to negotiate an additional credential;

FIG. 7 illustrates entities participating in a second scenario in which a remote device negotiates and receives an additional credential;

FIG. 8 illustrates messages of the second scenario;

FIG. 9 illustrates credential usage;

FIG. 10 illustrates an alternate environment for use of EAP and credential negotiation; and

FIG. 11 illustrates an alternative environment for use of a Kerberos credential.

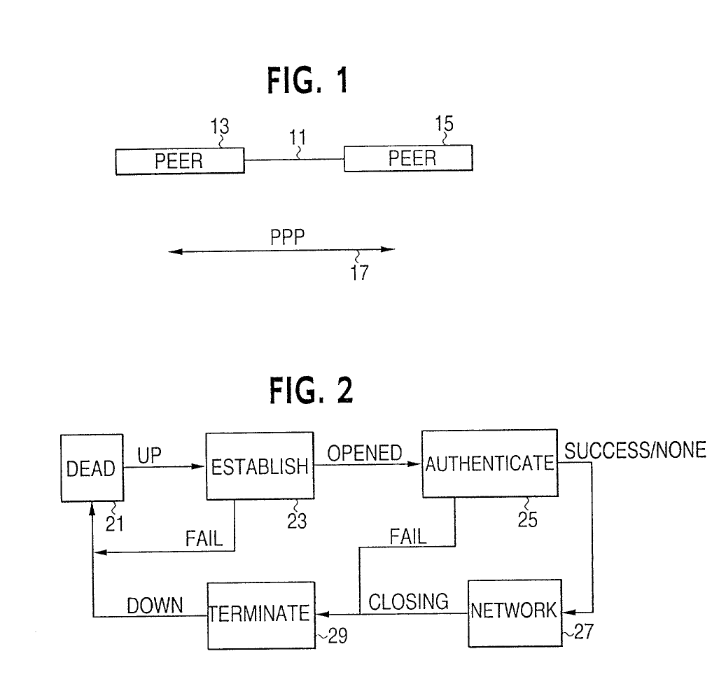

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention and preferred embodiments, the description taken with the drawings making apparent to those skilled in the art how the several forms of the present invention may be embodied in practice.

PPP and other network architectures provide for sometimes-optional authentication of peers. Various authentication protocols may be used. One authentication protocol is the PPP Extensible Authentication Protocol (“EAP”). A definition of the protocol can be found in the Network Working Group Request for Comments: 2284, “PPP Extensible Authentication Protocol (EAP)” (“EAP RFC”). Other Protocols may incorporate or otherwise permit use of EAP.

The invention makes use of some aspects of EAP. Several examples will be described with reference to PPP for ease of explanation. However, the invention may be readily applied in any architecture using or allowing EAP, such as architectures conforming with IEEE 802, particularly IEEE 802.1x. Within the PPP example, several scenarios are possible. Events common to the scenarios shall be discussed first.

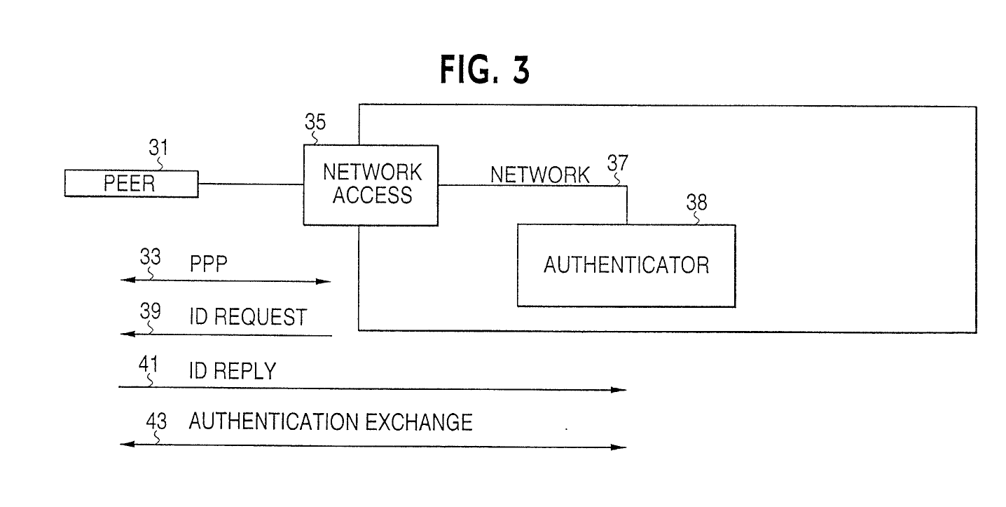

FIG. 3 illustrates steps in the formation of a connection common to several scenarios. A peer 31 initiates a PPP connection 33 with a Network Access Server 35. The Network Access Server 35 may support a dial-up modem, other modems, wireless LAN connections, or other physical attachments to the Network 37.

The peer 31 and the Network Access Server 35 proceed through the PPP Link Establishment Phase and enter the PPP Authentication Phase after negotiating EAP as an authentication protocol. The Network Access Server 35 sends an ID Request datagram 39 to the peer 31 to request identification information from the peer 31. The peer 31 responds with a reply 41 containing its identification. The format of the identification information may be a distinguished name in conformance with ITU Standard X.500, “Information Technology—Open Systems Interconnection—The Directory: Overview of Concepts, Models and Services.” Or it could be a Network Access Identifier NAI as defined by IETF Network Working Group Request for Comments: RFC 2486, “The Network Access Identifier.” The Network Access Server 35 may communicate the identification information and information from other, properly-formatted messages through the Network 37 to an authentication server (“Authenticator”) 38. Thereafter, information pertinent to authentication may be exchanged between the peer 31 and the Authenticator 38 via the Network Access Server 35. The peer 31 and the Authenticator 38 then exchange further authentication information 43, substantially in conformance with the EAP RFC.

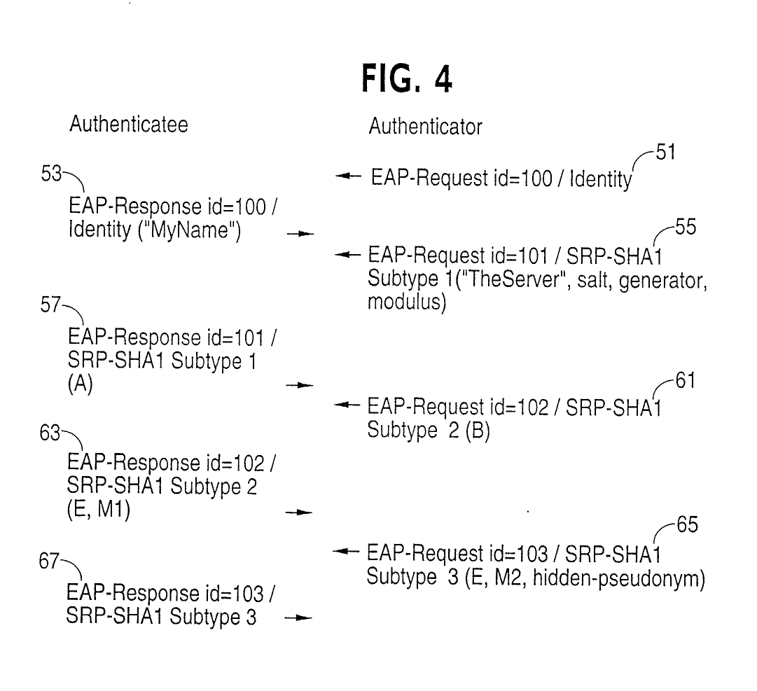

FIG. 4 illustrates messages exchanged between an authenticator and a peer common to several scenarios. In this figure, the peer is called the “Authenticatee” reflecting an example in which the Network Access Server requires identification of the peer. Authentication could be mutual. The Authenticator sends a message 51 with fields indicating message type (EAP-Request), message identification number (one hundred) and data “Identify.” The Authenticatee responds with a message 53 formatted according to the EAP RFC with fields indicating message type (EAP Response), identification number (one hundred, which corresponds to the associated ID Request message 51), and data (identity is “MyName”). Hereafter all messages associated with authentication will be presumed to be formatted according to the EAP RFC. It should be understood that EAP messages may be transported using protocols of other layers. For example, an EAP formatted message may be addressed to the Authenticator and transported across the network as a payload in network-layer-protocol datagram (e.g. using the Radius protocol).

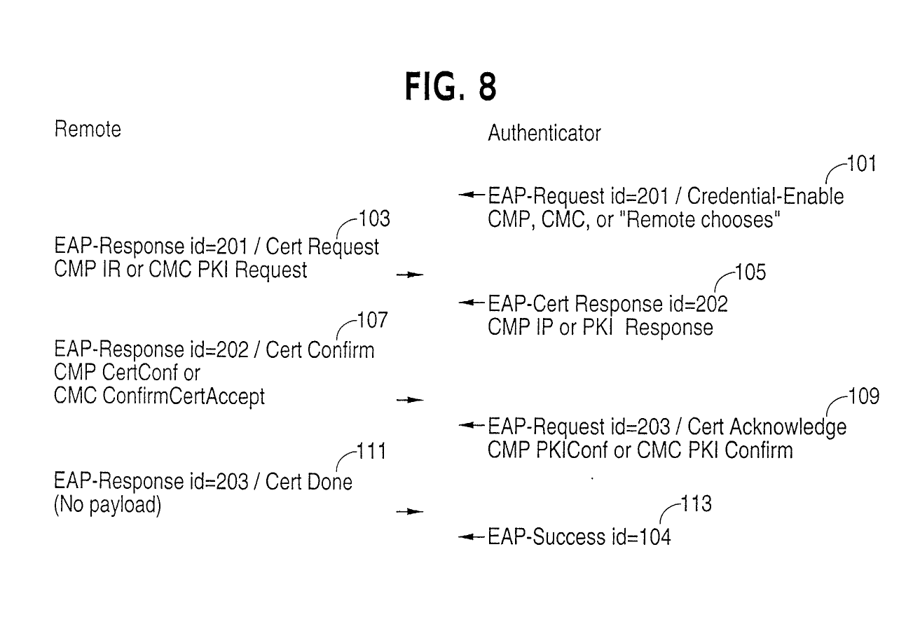

After obtaining identity information from the Authenticatee (and potentially after further processing of the identity information), the Authenticator sends a message 55 to the Authenticatee requesting that the Authenticatee engage in an authentication protocol, (in this case, the publicly-known SRP-SHA1 protocol). Authenticatee and Authenticator exchange additional messages 57, 61, 63, 65, 67 in accordance with the SRP-SHA1 protocol which is known in the art. Depending on the chosen authentication protocol, the AAA Server and Authenticatee may share a secret. That secret may be used in subsequent exchanges, an example of which will be discussed below with reference to FIG. 8. Upon successful completion of the SRP-SHA1 protocol, one of several scenarios may ensue.

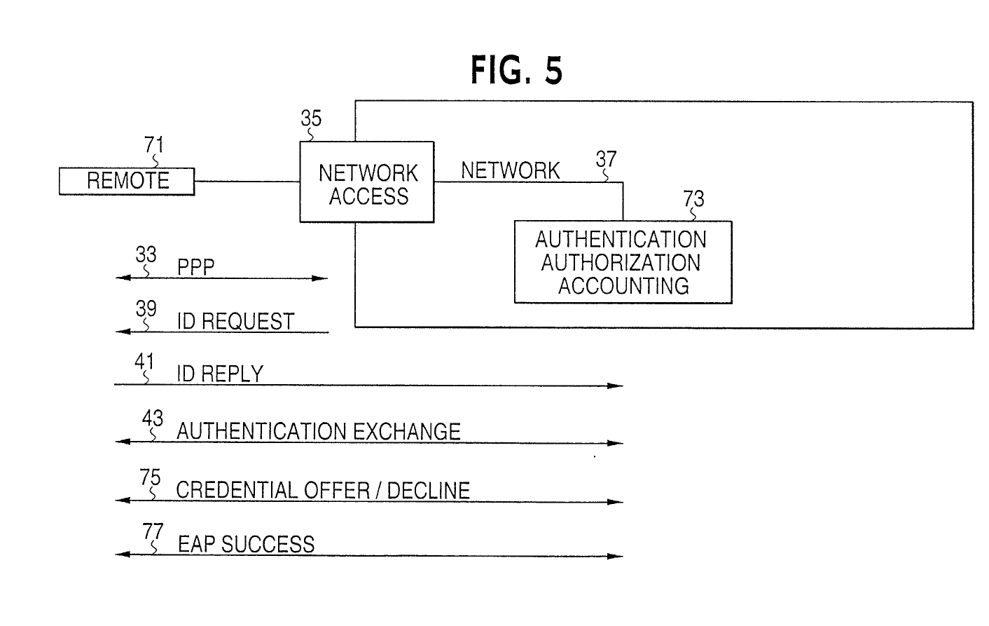

FIG. 5 illustrates entities participating in a first scenario. For purposes of this description, the entity performing the steps of the peer 31 of FIG. 3 or authenticatee of FIG. 4 shall be designated as a “Remote” 71. The entity performing the steps of the Authenticator 38 of FIGS. 3 and 4 shall be designated as a “Authentication, Authorization, and Accounting Server” (“AAA Server”) 73. The Network Access Server 35 and the Network 37 shall use the same designations as in FIGS. 3 and 5. As discussed with reference to FIG. 4, the Remote 71, the Network Access Server 35, and the AAA Server will have initiated a PPP connection 33, exchanged a request 39 and reply 41 for identification, and engaged in the authentication exchange 43 of FIG. 4. The AAA Server 73 and the Remote 71 will then exchange messages 75 to negotiate a further credential for use by the Remote for a network service (not shown). If the negotiation is not successful, the AAA Server 73 sends a message 77 signaling successful EAP authentication. The Network Access Server 35 will thereafter permit messages to pass more freely to the Network 37. For example, the Network Access Server 35 could then advance to the PPP Network Layer Protocol Phase and allow the Remote 71 to establish a Network Layer Protocol connection with resources on the Network 37.

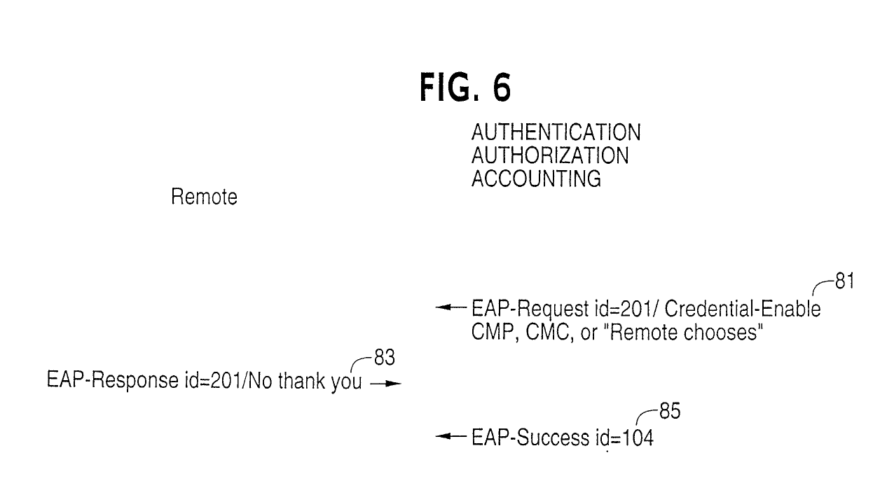

FIG. 6 illustrates messages of the first scenario. After a successful authentication exchange, the AAA Server makes an offer 81 to the Remote via the Network Access Server to obtain a further credential. (Hereafter, messages of the figure pass between the Remote and the AAA Server via the Network Access Server, even if the description does not expressly so state.) The Remote responds with a message 83 declining the offer. At this point in the scenario, the Network Access Server and the Remote have been in the PPP Authentication Phase. The AAA Server communicates a message 85 to the Remote indicating a successful EAP authentication exchange, because the Remote previously successfully completed the authentication exchange described in FIG. 4. The Network Access Server would then permit messages from the Remote to pass more freely to the Network 37, and the Remote and Network Access Server now may then advance state to the PPP Network Protocol Phase.

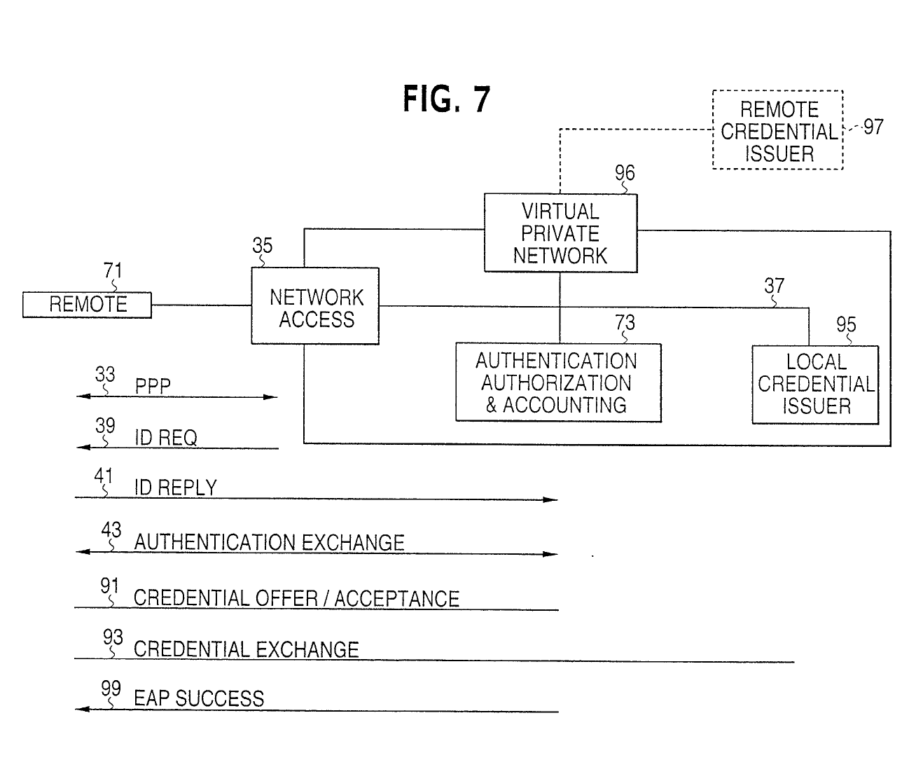

FIG. 7 illustrates entities participating in a second scenario in which the Remote negotiates and receives an additional credential. As discussed with reference to FIG. 4, the Remote 71, the Network Access Server 35, and the AAA Server 73 will have initiated a PPP connection 33, exchanged a request 39 and reply 41 for identification, and engaged in an authentication exchange 43. After a successful authentication exchange, the AAA Server and the Remote exchange messages 91 to negotiate a further credential for use by the Remote for a network service (not shown). If successful, the Remote then exchanges information 93 with a Local Credential Issuer 95 or Remote Credential Issuer 97 to obtain a credential. If the credential issuer is a process running on a server distinct from the AAA Server 73, the AAA Server 73 may extracted data from EAP-formatted messages exchanged with the Remote and relay the data in IP-formatted messages addressed from the AAA Server to the credential issuer. If the credential issuer is not local to the AAA server, the IP message may be routed through a Virtual Private Network 96. If the Local Credential Issuer 95 is a process operating on the same server as the AAA Server 73, information from the EAP messages may be passed internally from the AAA Server process to the credential issuer process. After completing the credential-issuance exchange 93, AAA Server 73 communicates a message 99 to Remote 71 indicating a successful EAP authentication exchange. The Network Access Server 35 would then permit messages from the Remote to pass more freely to the Network 37. The Remote 71 and the Network Access Server 35 then may advance state to the PPP Network Protocol Phase.

FIG. 8 illustrates messages of the second scenario. After a successful authentication exchange, the AAA Server makes an offer 101 to the Remote via the Network Access Server to obtain a further credential. (Hereafter, information passes between the Remote and the AAA Server or credential issuer via the Network Access Server, even if the description does not expressly so state.) The credential may be obtained in conformance with the IETF Network Working Group RFC 2510: “Internet X.509 Public Key Infrastructure Certificate Management Protocols” (“CMP”), or IETF Network Working Group RFC 2797: “Certificate Management Messages over CMS” (“CMS”). The credential may alternately be obtained in conformance with other protocols that might be supported by both the Remote and the AAA Server. The Remote responds with a message 103 requesting credential(s). (Additional messages may be exchanged to negotiate a commonly-supported credential type and issuance protocol.) Upon successful selection of an additional credential type and protocol, the AAA Server enables information to pass between the Remote and the credential issuer. The credential issuer then sends one or more messages 105 to Remote (via AAA server and Network Access Server) to supply the requested credential. Upon receipt of the credential, the Remote sends a message 107 accepting or rejecting the credential. The Remote may inspect the credential prior to acceptance, e.g., to verify that identification information for the Remote is correct, that the scope of network service authorization is appropriate, that a digital signature of the issuer is valid, etc. The AAA Server sends a message 109 acknowledging the acceptance of the credential by the Remote. The Remote then sends a message 111 signaling completion of the credential-issuance transaction. The AAA Server then sends an EAP success message 113 to the Remote. The Network Access Server would then permit messages from the Remote to pass more freely to the Network, and the Remote and Network Access Server then may advance state to the PPP Network Protocol Phase.

The credential may be an electronic datagram with properties that permit it to be used to enable access to a service other than network access. For example, the credential may be a Kerberos ticket or digital certificate complying with ITU Standard X.509, “Information Technology—Open Systems Interconnection—The Directory: Public-key and Attribute Certificate Frameworks.” If the credential is a digital certificate, the credential preferably will automatically expire within a relatively short period of time, such as an hour, or the anticipated duration of the Remote's connection to the service. The service may be any manner of service, such as data access, content distribution, electronic commerce transaction, etc. Where the protocol for obtaining a credential involves the use of a shared secret, such as in messages 101, 103, 105, and 107, the Remote and the AAA Server may use the same shared secret as was used during the EAP authentication exchange discussed above with reference to FIG. 4.

The AAA Server may act as a credential “broker” in the sense that it could serve as a distribution mechanism for different credentials types issued from different credential issuers in conformance with different protocols. After the AAA Server negotiates the selection of a credential, the AAA Server additionally manages communications with a selected credential issuer. The AAA Server can adapt messages to the remote according to the selected issuer, credential type, and protocol. The AAA Server can also adapt communications to the credential issuer. For example, if a credential would authorize the Remote to have limited access to particular digital content, such as a software distribution service, or medical record database, the AAA Server can request that the credential issuer issue a credential with appropriate authorization attributes. The AAA Server could select the precise format of the attributes based on information available to the AAA Server about the selected credential and issuer.

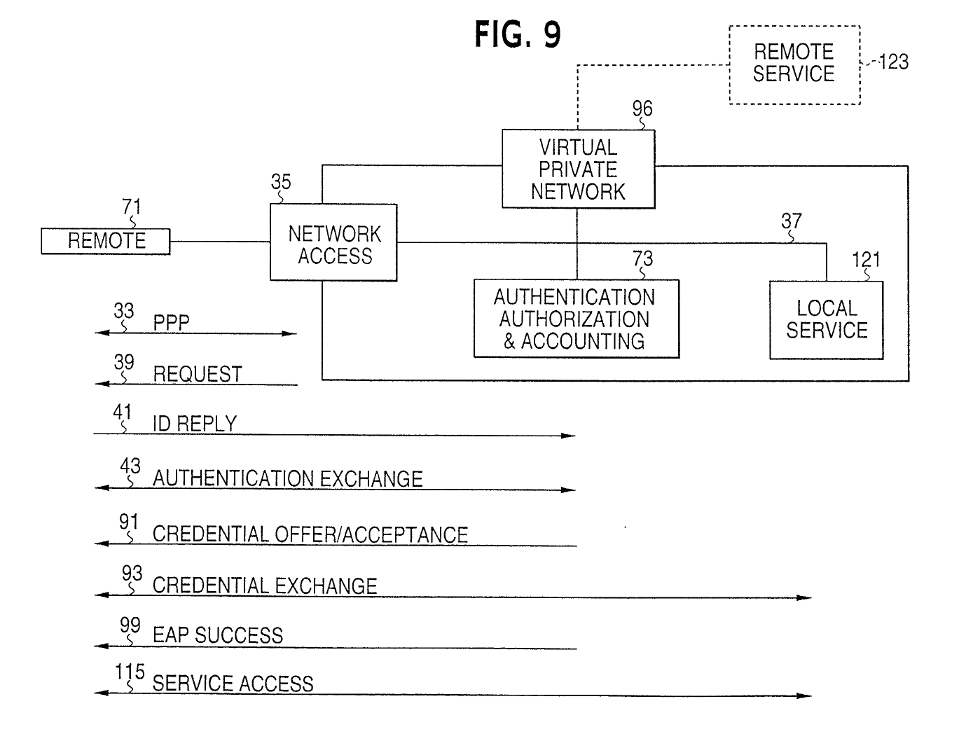

FIG. 9 illustrates credential usage. Having successfully completed EAP authentication, the Network Access Server 35 will allow datagrams 115 from the Remote 71 to pass relatively freely to the Network 37 for the purpose of accessing an otherwise restricted service. The Remote 71 may exchange datagrams 115 to access the service. The service may be provided by a Local Service Provider 121 located on the Network 37. Alternately, the Remote 71 may communicate with a Remote Service Provider 123 via Virtual Private Network 96.

Having read and understood the operation of credential distribution in association with EAP as described above, one of ordinary skill could configure other systems that are otherwise configured for, or configurable for, EAP to deliver credentials and perform other processes described above. Other applications potentially incorporating EAP include: (i) RADIUS extensions (Network Working Group, Internet-Draft, draft-aboba-radius-rfc2869bis-02.txt, “RADIUS Support For Extensible Authentication Protocol (EAP)”), (ii) Diameter NASREQ (AAA Working Group, Internet-Draft, draft-ietf-aaa-diameter-nasreq-09, “Diameter NASREQ Application”), (iii) Access PIB (IETF RAP Working Group draft-ietf-rap-access-bind-01.txt, “Framework for Binding Access Control to COPS Provisioning” and (iv) PIC (IETF IPSRA Working Group Internet Draft draft-ietf-ipsra-pic-05.txt, “PIC, A Pre-IKE Credential Provisioning Protocol).”

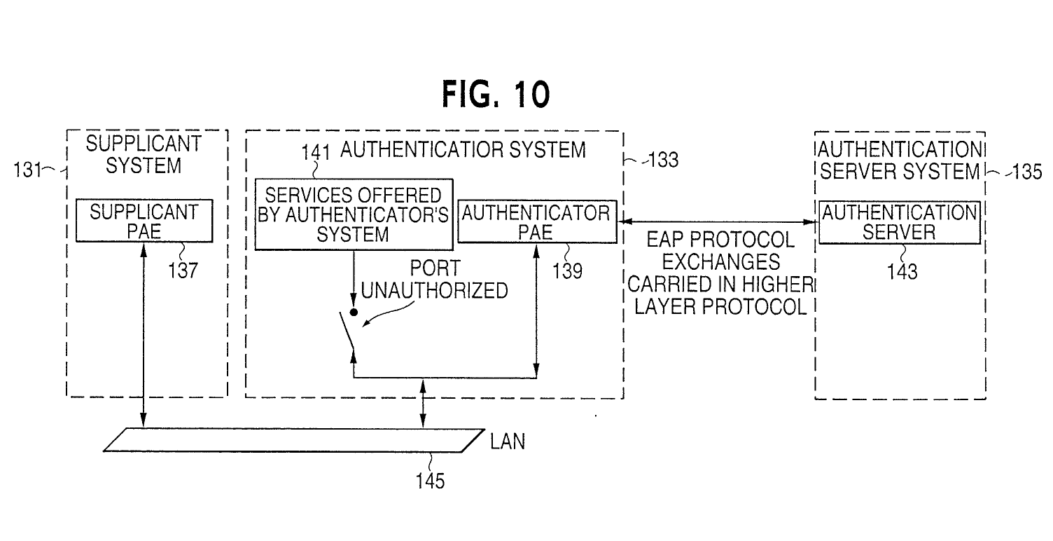

FIG. 10 illustrates application of EAP in an alternate telecommunication environment. This embodiment contemplates a IEEE Std. 802.11 wireless connection made between a remote device and a network using IEEE Std. 802.1x-2001, “IEEE Standard for Local and metropolitan area networks—Port-based Network Access Control” (“IEEE 802.1x”). FIG. 10 is adapted from IEEE 802.1x. An entity called a “Supplicant System” 131 includes a “Supplicant Port Access Entity” (“Supplicant PAE”) 137 that performs a role analogous to the Remote 71 of FIGS. 5 and 7. An “Authenticator System” 133 includes an “Authenticator Port Access Entity” (“Applicant PAE”) 139 that performs a role analogous to the Network Access Server 35 of FIGS. 5 and 7. An “Authentication Server System” 135 includes an Authentication Server 143 that performs a role similar to the AAA Server of FIGS. 5 and 7. The following description will illustrate general principles of credential distribution on association with EAP messaging in such an environment, with an understanding that other details of the embodiments disclosed above may also be adapted to an IEEE Std. 802.1x environment. Credential distribution in association with EAP messaging may also be adapted to any other environment where EAP or any of its variants may be implemented.

In the embodiment of FIG. 10, the Supplicant System 131 connects to the Authenticator System 133 via a communication channel, which may include a local area network 145. A portion of the link between the Supplicant System 131 and the Authenticator System 133 may be a wireless communication channel. The Authenticator System 133 communicates in turn with the Authentication Server System 135 through a link that may be a network using a network layer protocol.

The Authenticator System 133 performs a function illustrated in FIG. 10 as a switch. The Authenticator System 133 either (1) permits messages originating from the Supplicant System 131 to pass to Services 141 available on the Authenticator's system, or (2) blocks such messages from passing to the Services 141. When the Authenticator System 133 blocks messages, the port to the Services 141 is said to be “unauthorized.” When the Authenticator permits messages to pass, the port to the Services 141 is said to be “authorized.”

The Authenticator System 133 is defined in part by a state diagram, the details of which can be found in IEEE 802.1x. It is similar in one respect to the state diagram of PPP, in that the Supplicant PAE 137 and the Authenticator PAE 139 advance through a number of states leading (desirably) to a state in which the Authenticator System permits datagrams to pass relatively freely to its network. The Authenticator System 133 advances state in response to events, some of which are messages received from the Authentication Server 143. The Supplicant System 131, Authenticator System 133 and Authentication Server System 135 may exchanged EAP formatted messages in a process substantially similar to those illustrated in FIG. 4.

With particular reference to an IEEE 802.1x system, the state machine for the Authentication Server may be modified so that an EAP Success message is delayed while the Supplicant System 131 negotiates for an additional credential. The Authenticator System 133 will pass EAP formatted messages between the Supplicant PAE 137 and the Authentication Server 143, without need for special adaptation. (In the case of an IEEE 802.1x system, the Authenticator PAE 139 may encapsulate the EAP-formatted messages in a higher layer protocol in a manner described in IEEE 802.x1 and otherwise known in the art.) The, Authentication Server, in turn, may reformat the payloads of the EAP formatted messages and pass them to a credential issuer using techniques already known in the art.

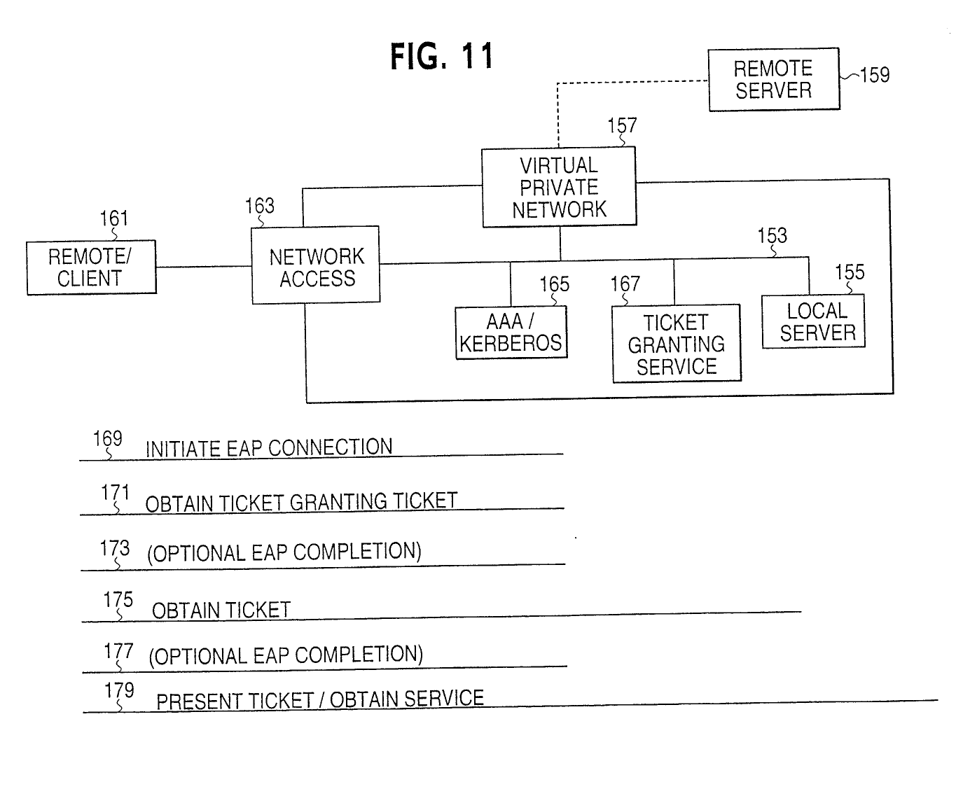

FIG. 11 illustrates an alternative environment for use of a Kerberos credential. Kerberos is a protocol known in other contexts. See, for example: Bruce Schneier, Applied Cryptography, 566-571, (John Wiley & Sons, Inc. 1996). In the environment of FIG. 11, a Network 153 supports a Local Server 155 that provides a service. The network may additionally, or alternately, provide access via a Virtual Private Network 157 to a Remote Server 159 that provides a service. The Network 153 permits access from a remote device by way of Network Access Server 163, which operates similarly to Network Access Servers discussed above with reference to other embodiments. The remote device will be referred to here as a “Remote/Client” 161. The Network 153 also supports a AAA/Kerberos Server 165, which may include a Kerberos process operating on a AAA Server of the type described above with reference to other embodiments. In FIG. 11, the AAA/Kerberos Server 165 runs both an AAA process and a Kerberos process. The Network 153 further supports a Ticket Granting Service 167, which will be discussed more fully below. The Ticket Granting Service 167 may be a stand-alone device or a process running on the AAA/Kerberos server, or a process running on a server running other processes. The Kerberos process and the Ticket Granting Service 167 may alternately be located outside the Network 153 but accessible through the Virtual Private Network 157.

In operation, the Remote/Client 161 seeks access to a service through the Network 153. The Remote/Client 161 initiates an EAP connection 169 with an AAA process operating on the AAA/Kerberos Server 165. As part of the EAP process, the Client/Remote 161 negotiates to obtain a Kerberos Ticket Granting Ticket 171. General protocols for issuance of Kerberos Ticket Granting Tickets are known.

After obtaining the Ticket Granting Ticket, the AAA process on the AAA/Kerberos Server 165 may optionally conclude the EAP process 173. Thereafter, the Network Access Server 163 will permit more general access to the Network 153, including passing messages from the Client/Remote to the to the Ticket Granting Service 167 (rather than restricting the messages to the AAA process). The Remote/Client 161 would present the Ticket Granting Ticket and other information to the Ticket Granting Service 167 using a known Kerberos protocol to obtain, from the Ticket Granting Service 167, another credential known as a Ticket 175.

In a variation of the process above for obtaining a ticket, the AAA process would not complete the EAP protocol immediately upon issuance of the Ticket Granting Ticket. Instead, the Client/Remote would obtain a Ticket by continuing to send EAP formatted messages to the AAA process, and the AAA process would relay communications to the Ticket Granting Service 167. (This sequence may be used when the Ticket Granting Service 167 is integrated with, or otherwise running on the AAA/Kerberos server 165. After issuance of a Ticket (or multiple Tickets), the AAA process would complete the EAP process 177.

Regardless of whether the AAA process completes the EAP process after issuance of a Ticket Granting Ticket or after issuance of a Ticket, the Remote/Client would be given more general access to the network upon EAP completion and would present at least a Ticket to the Local Server 155 (or Remote Server 159) to gain access to a service 179.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses.

The EAP RFC is incorporated herein by reference in its entirety.

What is claimed is:

1. A telecommunication method comprising:
(a) initiating an EAP connection between a requestor and a network authenticator via an access point, where the access point is configured to selectively permit access to the network, and where the authenticator is configured to selectively authorize access to the network;
(b) authenticating the requestor to the authenticator; and
(c) prior to signaling successful EAP completion, negotiating to provide a credential for the requestor, where the credential grants an authorization other than network access.

2. The method of claim 1 further comprising a step of providing the credential to the requester prior to signaling successful EAP completion.

3. The method of claim 2 where the step of providing the credential uses a secret used during EAP authentication.

4. The method of claim 1 where the credential may be a particular type of credential selected from a set of different types of credentials.

5. The method of claim 4 where credentials from multiple credential-issuing parties may be available to the requestor via the network access point.

6. The method of claim 5 where the network authenticator makes communications to the requester that are specific to a selected credential type.

7. The method of claim 5 where the network authenticator makes communications to the requestor that are specific to a selected credential issuer.

8. The method of claim 5 where the network authenticator enables communication to a credential issuer that are specific to the requestor.

9. A server configured to authorize access of a requestor to a network using messages conforming to an EAP protocol, said server further configured to negotiate for the provision of a credential for the requester prior to signaling successful EAP completion, where the credential authorizes the requester to access a network service other than network access.

10. The server of claim 9 where the server is further configured to provide the credential prior to signaling successful EAP completion authentication.

11. The server of claim 10 where the server is further configured to provide the credential using a secret used during EAP authentication

12. The server of claim 9 where the server is further configured to negotiate for the provision of credentials from multiple credential issuers.

13. The server of claim 9 where the server is further configured to negotiate for the provision of multiple types of credentials.

14. The server of claim 9 where the server is further configured to enable communications to a credential issuer that are specific to the requestor.

15. An electronic device configured to establish communications with a network using messages conforming to an EAP protocol, said electronic device further configured to negotiate for the provision of a credential prior to receiving an indication of successful EAP completion authentication, where the credential authorizes the electronic device to access a network service other than network access.

16. The electronic device of claim 15, where the electronic device is further configured to receive the credential prior to receiving an indication of successful EAP completion.

17. The electronic device of claim 16, where the electronic device is further configured to receive a credential issued using a secret used during EAP authentication.

18. The electronic device of claim 15 where the electronic device is further configured negotiate for the provision of credentials from multiple credential issuers.

19. The electronic device of claim 15 where the electronic device is further configured to negotiate for the provision of multiple types of credentials.

20. A sequence of formatted electronic messages, each message conforming with an EAP message format, the message sequence comprising:
(a) a first message signifying an offer to negotiate a credential to access a network service other than network access; and
(b) a second message subsequent to the first message signifying EAP completion.

21. A sequence of formatted electronic messages, each message conforming with an EAP message format, the message sequence comprising:
(a) a first message identifying a protocol for obtaining a credential to access a network service other than network access; and
(b) a second message subsequent to the first message signifying EAP completion.

22. A sequence of formatted electronic messages, each message conforming with an EAP message format, the message sequence comprising:
(a) a first message carrying information for use in a credential to access a network service other than network access, and
(b) a second message subsequent to the first message signifying EAP completion.

23. A sequence of formatted electronic messages, each message conforming with an EAP message format, the message sequence comprising:
(a) a first message carrying a credential to access a network service other than network access, and
(b) a second message subsequent to the first message signifying EAP completion.

24. A sequence of formatted electronic messages, each message conforming with an EAP message format, the message sequence comprising:
(a) a first message carrying a first credential for use in obtaining a second credential; and
(b) a second message subsequent to the first message signifying EAP completion.

25. A sequence of formatted electronic messages, each message conforming with an EAP message format, the message sequence comprising:
(a) a first message carrying a first credential for use in obtaining a second credential;
(b) a second message carrying a second credential to access a network service other than network access; and
(c) a third message subsequent to the second message signifying EAP completion.
